(19) United States
(12) Patent Application Publication
(10) Pub. No.: US 2008/0192404 A1
(43) Pub. Date: Aug. 14, 2008

(54) ANTI-STATIC WRIST BAND AND ANTI-STATIC WRIST BAND SET

(75) Inventor: Tomohide Nakajima, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/021,700

(22) Filed: Jan. 29, 2008

(30) Foreign Application Priority Data
Feb. 8, 2007 (JP) 2007-029854

(51) Int. Cl. H05F 3/00; H05F 3/02

(52) U.S. Cl. 361/220; 361/212

(57) ABSTRACT

An anti-static wrist band includes: a band, a first electrode supported on the band, a first conductive gel disposed on the first electrode, a second electrode supported on the band and insulated from the first electrode and the first conductive gel, and a second conductive gel insulated from the first electrode and the first conductive gel and disposed on the second electrode.

### BACKGROUND

1. Field

The present disclosure relates to an anti-static wrist band and an anti-static wrist band set used by an operator when static electricity escapes from the operator to ground.

2. Description of the Related Art

A wrist band is formed from a band, an electrode is supported on the band, and a conductive cable is connected to the electrode. The conductive cable is grounded. When the band is wrapped around the wrist of an operator, the electrode makes contact with the operator's skin. The voltage of the human body flows from the operator's skin to the electrode. In this manner, static electricity escapes from the operator to ground.

A carriage is mounted into a hard disk drive. A head suspension assembly is mounted on the carriage. A magnetic head element is supported on the head suspension in the head suspension assembly. The carriage becomes electrically charged while assembling the hard disk drive. When a conductive object makes contact with this type of carriage, a static electricity discharge will occur from the carriage and an electrical current will flow due to the static electricity discharge. A secondary induced current will flow due to the action of electromagnetic induction in the magnetic head element. This type of secondary induced current can damage the magnetic head element. Using a wrist band can prevent the carriage from charging. Reference documents are Japanese Laid-open Patent Publication No. 2000-311795 and examined Japanese utility model No. 2557837.

The contact resistance between a wrist band and skin will vary depending on looseness of the band and dryness of the skin. As a result, the charge voltage of the human body cannot be controlled to +/−5 V or less. If the charge voltage of the human body can not be controlled to +/−5 V or less, the charge voltage of the carriage will not be able to drop to +/−5 V even if a wrist band is used. If a static electricity discharge occurs based on a charge voltage of +/−5 V, the secondary induced current will exceed the current withstand value of the magnetic head element.

This technology takes the conditions described above into consideration and has an objective of providing an anti-static wrist band set that can reliably control the voltage of the human body to +/−5 V or less.

### SUMMARY

This disclosed technique was produced for solving the problems due to the foregoing related techniques. In keeping with one aspect of the technique, an anti-static wrist band includes: a band, a first electrode supported on the band, a first conductive gel disposed on the first electrode; a second electrode supported on the band and insulated from the first electrode and the first conductive gel, and a second conductive gel insulated from the first electrode and the first conductive gel and disposed on the second electrode.

### BRIEF DESCRIPTION OF THE DRAWINGS

FIG. 1 is a perspective view showing the construction of the anti-static wrist band set related to a first embodiment of this technology;

FIG. 2 is a disassembled perspective view of the anti-static wrist band and ground cable;

FIG. 3 is a plan view showing the rear side of a unit;

FIG. 4 is a cross-sectional view along line 4-4 of FIG. 1;

FIG. 5 is a conceptual view showing a usage method of the anti-static wrist band set of FIG. 1;

FIG. 6 is a graph showing a charge voltage value of the anti-static wrist band set related to this technology;

FIG. 7 is a graph showing a charge voltage value a conventional anti-static wrist band set;

FIG. 8 is a perspective view showing the construction of the anti-static wrist band set related to a second embodiment of this technology.

### DETAILED DESCRIPTION OF THE EMBODIMENT

In the following, an embodiment of this technology will be described referring to the attached drawings.

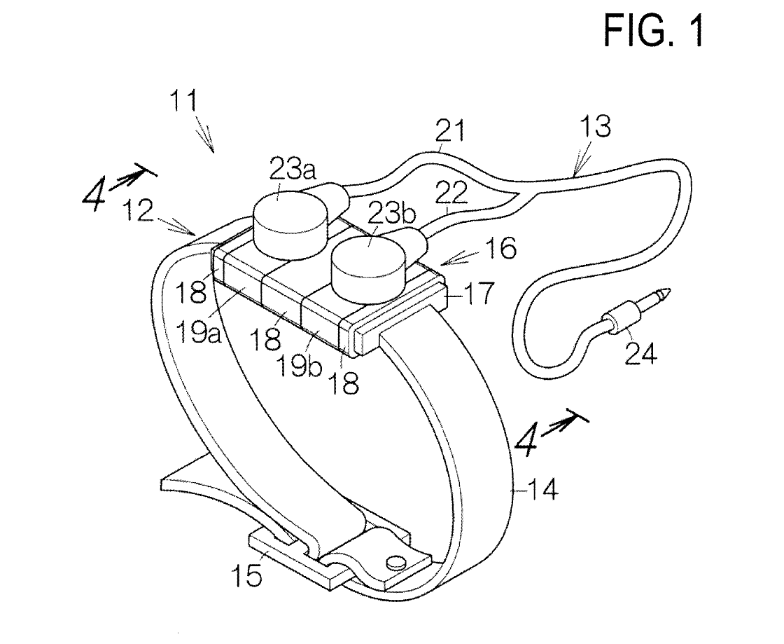

FIG. 1 schematically shows the construction of the anti-static wrist band set 11 related to the first embodiment of this technology. This anti-static wrist band set 11 is built from an anti-static wrist band 12 and a ground cable 13. The anti-static wrist band 12 is worn on, for example, the operator's wrist.

The anti-static wrist band 12 has a band 14. The band 14 is formed from a material that can expand and contract. Furthermore, a length adjustment mechanism 15 is also connected to the band 14. Therefore, the band 14 can be reliably wrapped on the operator's wrist. Looseness of the band 14 can also be eliminated.

A main unit 16 is attached to the band 14. The main unit 16 is made up of a unit body 17. A three row guide 18 is formed on the unit body 17. The guide 18 goes around the band 14 one time over the front and rear of the band 14. A first and second conductive gel 19a, 19b are arranged between both adjacent guides 18. The first and second conductive gels 19a, 19b are wrapped on the unit body 17 by the rotation of the band 14. The first and second conductive gels 19a, 19b can also be wrapped extending over many turns. The first and second conductive gels 19a, 19b are insulated from each other by the center guide 18. The guide 18 prevents lateral shifting of the first and second conductive gels 19a, 19b on the unit body 17. The guide 18 functions as a guide member related to this technology.

The ground cable 13 contains first and second conductive cables 21, 22. First and second removable electrodes 23a, 23b are linked to the tips of the first and second conductive cables 21, 22, respectively. The first and second removable electrodes 23a, 23b are separately linked to the main unit 16 so as to be freely removable. A plug 24 is connected in common to the first and second conductive cables 21, 22. The first and second conductive cables 21, 22 are separately connected to the inside and outside terminals of the plug 24.

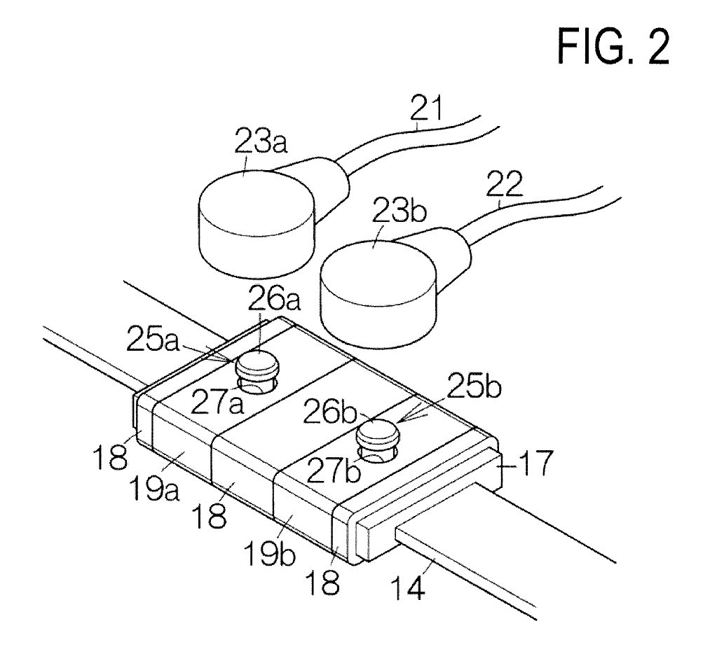

As shown in FIG. 2, first and second electrodes 25a, 25b are supported on the unit body 17. The first and second electrodes 25a, 25b are formed from first and second electrode protrusions 26a, 26b. The first and second electrode protrusions 26a, 26b both protrude from the surface of the first and second conductive gels 19a, 19b on the front side of the unit body 17. First and second through holes 27a, 27b are formed on the first and second conductive gels 19a, 19b, respectively. The first through hole 27a accepts the first electrode protrusion 26a. The second through hole 27b accepts the second electrode protrusion 26b. In this manner, removing of the first and second conductive gels 19a, 19b is reliably prevented.

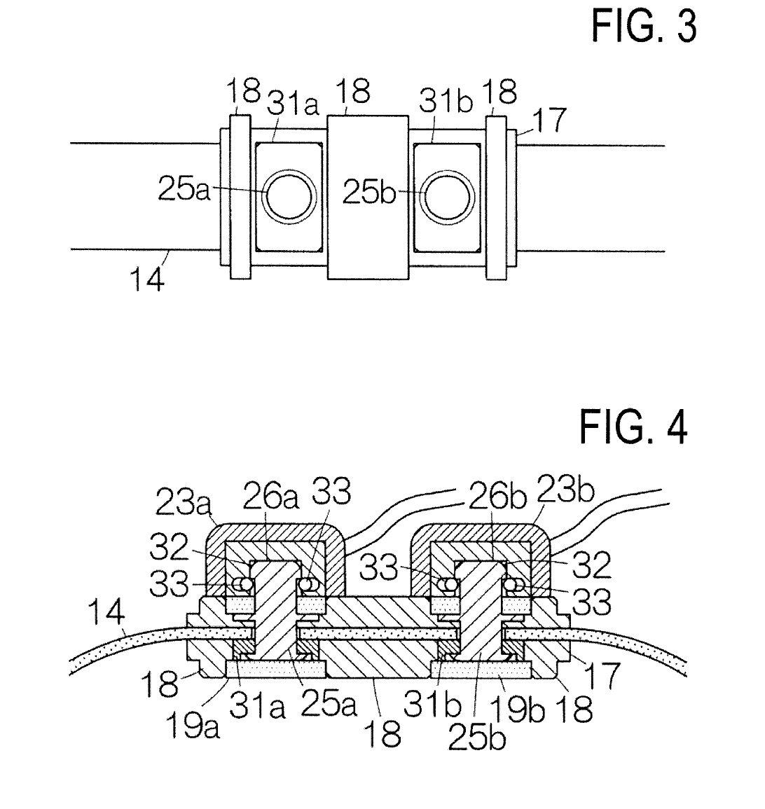

As shown in FIG. 3, the first and second electrodes 25a, 25b are equipped with flat plate-shaped first and second electrodes 31a, 31b. The first and second electrodes 31a, 31b separately overlap the band 14 at the rear side of the unit body 17. The first and second electrodes 31a, 31b are arranged on the inside of the first and second conductive gels 19a, 19b, respectively, wrapped on the unit body 17. In other words, the surfaces of the first and second electrodes 31a, 31b are covered by the first and second conductive gels 19a, 19b, respectively.

As shown in FIG. 4, the first and second electrodes 31a, 31b are linked to the first and second electrode protrusions 26a, 26b. The base of the first and second electrode protrusions 26a, 26b can be crimped to the first and second electrodes 31a, 31b. The first and second electrode protrusions 26a, 26b pass through the band 14. An expansion member 32 is formed on the ends of the first and second electrode protrusions 26a, 26b. In connection with this, a pair of cylindrical spring members 33 is incorporated into both of the first and second removable electrodes 23a, 23b. The cylindrical spring members 33, 33 extend parallel to each other inside each of the removable electrodes 23a, 23b. The space between the cylindrical spring members 33, 33 is set to be smaller than the expansion member 32 of the first and second electrode protrusions 26a, 26b. Simultaneously with this, the space between the cylindrical spring members 33, 33 is set to be smaller than the constriction of the first and second electrode protrusions 26a, 26b. Therefore, slipping of the expansion member 32 from between the cylindrical spring members 33, 33 is prevented when the expansion member 32 of the first and second electrode protrusions 26a, 26b passes between the cylindrical spring members 33, 33 while wearing the first and second removable electrodes 23a, 23b. If the first and second removable electrodes 23a, 23b is pulled in opposition to the elastic force of the cylindrical spring members 33, 33, the first and second removable electrodes 23a, 23b can be removed from the first and second electrodes 25a, 25b.

The first electrode 25a is arranged between both of the adjacent guides 18, 18. Simultaneously with this, the second electrode 25b is arranged between both of the adjacent guides 18, 18. In this manner, the first electrode 25a and the second electrode 25b are isolated from each other by the center guide 18. The first electrode 25a is insulated from the second electrode 25b. Resin covers are installed on both the first and second removable electrodes 23a, 23b. The first removable electrode 23a is reliably insulated from the second removable electrode 23b.

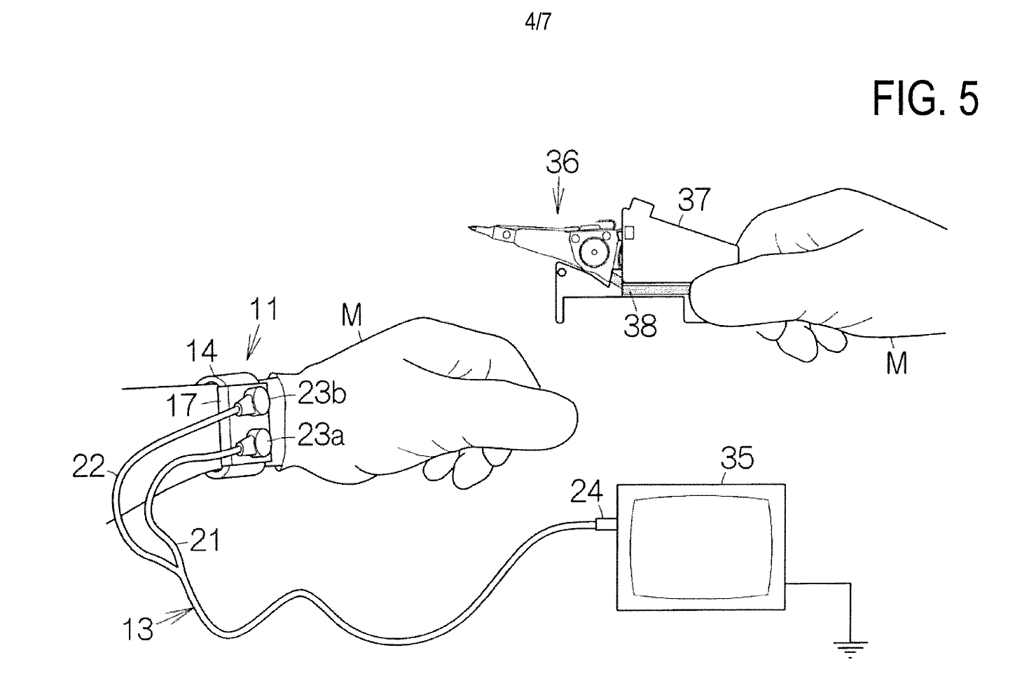

Now, we will assume a situation in which an operator is wearing the anti-static wrist band 12. As shown in FIG. 5, the operator M has a band 14 wrapped around the wrist. If the band 14 is tightened using a length adjustment mechanism 15, the rear side of the unit body 17 will be pressed against the wrist of the operator M by the expansion/contraction force of the band 14. The first and second conductive gels 19a, 19b adhere to the skin of the operator M. Even if the band 14 becomes loose while working, the first and second conductive gels 19a, 19b make it possible to maintain adhesion.

The first and second removable electrodes 23a, 23b are connected to the first and second electrodes 25a, 25b, respectively. In addition to this, the plug 24 is inserted into the jack of a voltage monitor 35. Voltage values are displayed in the voltage monitor 35. The voltage monitor 35 is grounded. In this manner, the first and second conductive gels 19a, 19b, the first and second electrodes 25a, 25b, the first and second removable electrodes 23a, 23b, and the first and second conductive cables 21, 22 form a current path from the skin to the ground. Static electricity of the human body flows through the first and second conductive gels 19a, 19b, the first and second electrodes 25a, 25b, the first and second removable electrodes 23a, 23b, the first and second conductive cables 21, 22, and the voltage monitor 35. Static electricity of the human body escapes to ground. As a result, the charge voltage of the human body can be controlled to +/−1 V or less. Here, the operator can also verify the charge voltage of the human body based on the display of the voltage monitor 35.

We will assume a situation in which the operator M is holding the carriage 36 for the hard disk drive. The operator M wears, for example, nitrile rubber gloves while holding the carriage. The nitrile rubber gloves exhibit a non-specific charge prevention function. A holder 37 made from resin is installed in the carriage 36. A conductor 38 is attached to the holder 37. The conductor 38 makes contact with the carriage 36. When the holder 37 is pinched by the operator's fingers, the operator's fingers will make contact with the conductor 38. The contact resistance between the carriage 36 and the operator M is reduced to the maximum degree.

A plurality of head suspension assemblies are supported on the carriage block in the carriage 36. The carriage block is formed from, for example, aluminum. Casting is used while forming the carriage block. A floating head slider is loaded on the head suspension in each head suspension assembly. The head suspension can also be formed from, for example, stainless steel or aluminum. A sheet metal punching process can be used while forming the head suspension.

The floating head slider is made up of, for example, a hard main slider. The main slider is formed from Al₂0₃—TiC. A soft Al₂0₃ film is laminated on one end of the main slider. A so-called magnetic head, namely an electromagnetic conversion element (not shown in the figure), is embedded in the Al₂0₃ film. The electromagnetic conversion element is made up of a write element and a read element. A thin film magnetic head or a single magnetic pole head can be used for the write element. These heads utilize a magnetic field generated by a conductive thin film coil pattern to write information to a magnetic disk. A giant magnetoresistive head (GMR) element or a tunnel junction magnetoresistive element (TMR) can be used for the read element. These elements utilize changes in resistance of a spin valve film or a tunnel junction film to read information from a magnetic disk.

When the operator M grasps the holder 37, the static electricity of the carriage 36 flows from the conductor 38 to the operator M. If the charge voltage of the operator M is controlled to +/−1 V or less, the charge voltage of the carriage 36 can be controlled to +/−1 V or less. As a result, even if the carriage 36 makes contact with a conductor during operation, a static electricity discharge can be avoided. If a static electricity discharge can be avoided, a secondary induced current based on the static electricity discharge in a read element can be avoided. This makes it possible to reliably avoid damage to the read element.

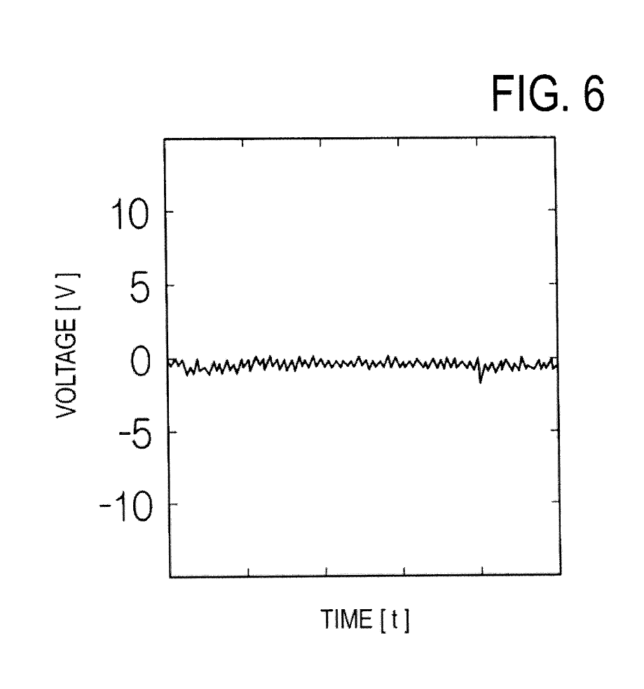

A technician measured the charge voltage of a human body. During the measurement, the anti-static wrist band 12 was worn on the left wrist of the test subject. The plug 24 was inserted into the jack of the voltage monitor 35. Meanwhile, the test subject grasped a so-called charge plate using their right hand. A static electricity measurement device was connected to the charge plate. The test subject generated static electricity by walking. Time variations of the charge voltage were measured by the static electricity measurement device. As a result, the charge voltage of a human body was confirmed to be +/−1 V or less as shown in FIG. 6.

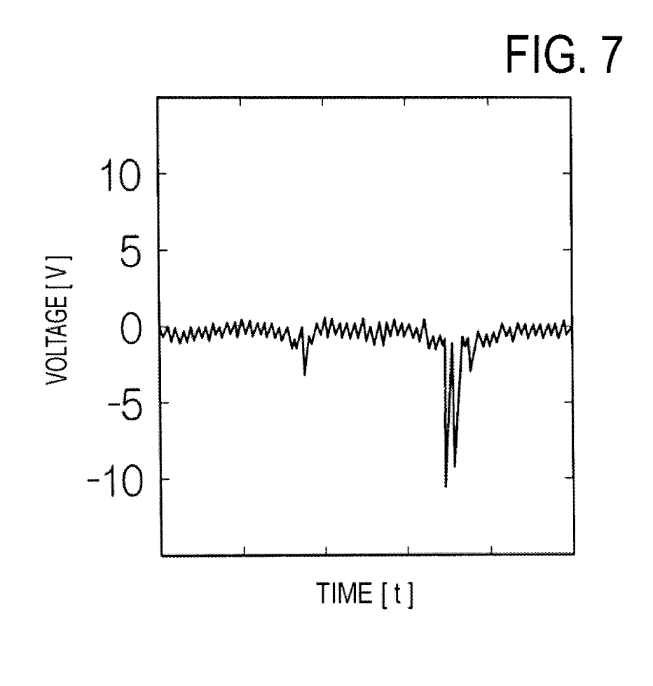

A conventional anti-static wrist band was prepared for the test subject. The first and second conductive gels 19a, 19b were omitted in this anti-static wrist band. The first and second electrodes 25a, 25b were pressed onto the skin of the test subject. In addition to this, conditions were established identical to the above. As a result, the charge voltage of a human body was confirmed to exceed +/−5 V as shown in FIG. 7.

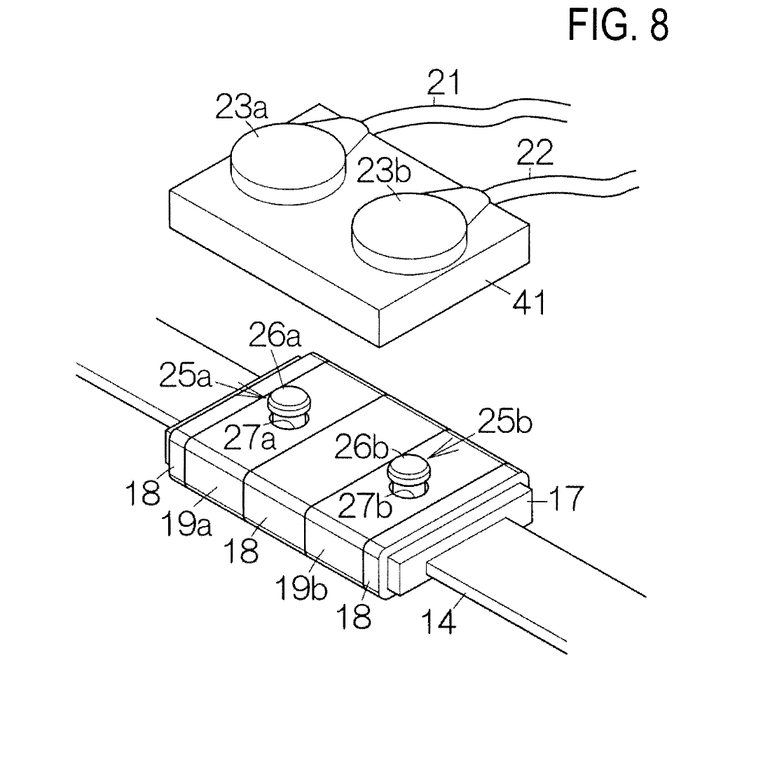

FIG. 8 shows the anti-static wrist band set 11a related to the second embodiment of this technology. In this anti-static wrist band set 11, the first and second removable electrodes 23a, 23b are supported on the electrode unit body 41. In other words, the first and second removable electrodes 23a, 23b are integrally formed with the electrode unit body 41. The electrode unit body 41 covers the first and second conductive gels 19a, 19b. As a result, dropping of the first and second conductive gels 19a, 19b can be prevented with even more reliability. In addition to this, reference symbols identical to the composition equal to the first embodiment are added.

According to this technology, an anti-static wrist band and anti-static wrist band set are provided which can reliably control human voltage to +/−5 V or less.

What is claimed is:

1. An anti-static wrist band comprising
a band;
a first electrode supported on said band;
a first conductive gel disposed on said first electrode;
a second electrode supported on said band and insulated from said first electrode and said first conductive gel; and
a second conductive gel insulated from said first electrode and said first conductive gel and disposed on said second electrode.

2. An anti-static wrist band according to claim 1, further comprising:
a first electrode protrusion formed on said first electrode protruding towards the outside,
a first through hole formed on said first conductive gel to accept said first electrode protrusion,
a second electrode protrusion formed on said second electrode protruding towards the outside, and
a second through hole formed on said second conductive gel to accept said second electrode protrusion.

3. An anti-static wrist band according to claim 2, further comprising:
a guide member extending along the edge of said first conductive gel.

4. An anti-static wrist band according to claim 3, further comprising:
a guide member extending along the edge of said second conductive gel.

5. An anti-static wrist band comprising:
a band;
a first electrode supported on said band;
a first conductive gel disposed on said first electrode;
a second electrode supported on said band and insulated from said first electrode and said first conductive gel;
a second conductive gel insulated from said first electrode and said first conductive gel and disposed on said second electrode;
a first removable electrode connected to the end of a first conductive cable and coupled to said first electrode so as to be freely removable; and
a second removable electrode connected to the end of a second conductive cable and coupled to said second electrode so as to be freely removable.

6. An anti-static wrist band according to claim 5, further comprising:
a first electrode protrusion formed on said first electrode protruding towards the outside;
a first through hole formed on said first conductive gel to accept said first electrode protrusion;
a second electrode protrusion formed on said second electrode protruding towards the outside; and
a second through hole formed on said second conductive gel to accept said second electrode protrusion.

7. An anti-static wrist band according to claim 5, further comprising:
an electrode unit that supports said first removable electrode and said second removable electrode as well as covers said first conductive gel and said second conductive gel.

8. An anti-static wrist band s according to claim 5, further comprising:
a guide member extending along the edge of said first conductive gel.

9. An anti-static wrist band according to claim 8, further comprising:
a guide member extending along the edge of said second conductive gel.
